(19) United States
(12) Patent Application Publication
(10) Pub. No.: US 2002/0104374 A1
(43) Pub. Date: Aug. 8, 2002

(54) Method for controlling pneumatic tire pressures during dynamic vehicle test procedures

(76) Inventor: Paul A. Merendino SR., Mogadore, OH (US)

Correspondence Address: John H. Hornickel, Chief Intellectual Property Counsel, Bridgestone/Firestone, Inc., 1200 Firestone Parkway, Akron, OH, 44317, US

(21) Appl. No.: 09/778,339

(22) Filed: Feb. 7, 2001

(51) Int. Cl. B60C 23/02

(52) U.S. Cl. 73/146.3

(57) ABSTRACT

A method of testing a tire wherein a tire/wheel assembly (10), including the test tire (22) on which tire-related measurements are taken during multiple test runs. The pressure within the test tire (22) is maintained at a desired test pressure throughout the multiple test with a pressure-controlling device (20) mounted on the tire/wheel assembly (10). The pressure-controlling device (20) measures actual tire pressure, compares the measured tire pressure to the desired test pressure, and adjusts the tire pressure accordingly. Usually, there will be increase in tire pressure due to increased temperature during latter test runs whereby the adjustment can be performed by releasing fluid from the tire opening by, for example, opening a normally closed solenoid valve (48) to bleed air from the tire (22). The releasing step may be performed when the tire/wheel assembly (10) is at rest between test runs, in which case the pressure-controlling device (20) could include a motion detector.

### FIELD OF THE INVENTION

This invention relates generally as indicated to a method for controlling pneumatic tire pressures during test procedures and, more particularly, to the use of a pressure-controlling device mounted on a test tire during the test procedures.

### BACKGROUND OF THE INVENTION

The trend in the tire and automobile industry is to closely match and design a particular tire as original equipment for a particular vehicle. Specifically, automobile manufacturers commonly equip a vehicle with a set of tires which have been found to provide the most desirable wear and ride characteristics for that particular vehicle. To this end, a number of tests are performed on tires to determine their suitability for a specific vehicle. While a road wheel may be used in a laboratory setting to test certain characteristics of an individual tire, the suitability of a tire for a specific vehicle usually requires dynamic vehicle testing to take into account the structure of a particular vehicle (e.g., its suspension system, weight, etc.) has on the tire characteristics.

In a dynamic vehicle testing method used by the assignee of the present invention, a vehicle (with the test tires installed thereon) is driven so that the relevant tire forces and footprints are measured. Instrumentation associated with the vehicle and test surface is used to measure the desired tire properties and a contact patch photograph can be taken. Alternatively, the tire-wheel system can be rolled against a test drum over multiple test runs via use of an external loading frame whereby no vehicle is required.

During a dynamic vehicle test, this process is repeated many times to collect enough data to statistically reach a desired confidence level in the evaluation. It is important that conditions remain set during the multiple test runs so that there is no unknown inconsistency skewing the data from different runs.

### SUMMARY OF THE INVENTION

The present invention provides a method of maintaining the pressure within a test tire installed on a vehicle being driven on multiple test runs to evaluate dynamic tire performance. During such multiple test runs, the temperature of the tire often increases thereby increasing the pressure within the tire. The present invention eliminates this pressure increase and thus minimizes any data inconsistencies which would have resulted from tire pressure changes.

More particularly, the present invention provides a method of testing a tire wherein a tire/wheel assembly (including the test tire) is mounted on a vehicle and tire-related measurements are taken while the vehicle is being driven on multiple test runs. For example, the vehicle can be driven so that the relevant tire/wheel assembly rolls over a plate having associated instrumentation to measure tire properties. The pressure within the test tire is maintained at a desired test pressure throughout the multiple test runs so that consistent data may be compiled from the multiple test runs to evaluate tire performance.

The pressure is maintained with a pressure-controlling device which is mounted on the tire/wheel assembly. For example, the tire/wheel assembly can have a rotating mounting surface on which the pressure-controlling device is mounted whereby the device rotates with the tire/wheel assembly when the vehicle is being driven. The desired test pressure can be preset prior to the test runs so that the pressure-controlling device can be compatible with different types of tires.

The pressure is maintained within the test tire by measuring the actual tire pressure, comparing the measured tire pressure to the desired test pressure, and adjusting the tire pressure if the measured tire pressure differs from the desired test pressure by 1/36th of 1 psi (0.028 psi). This adjustment can be performed by releasing fluid from the tire opening by, for example, opening a normally closed solenoid valve to bleed air from the tire. The releasing step may be performed when the vehicle is at rest between test runs, in which case the pressure-controlling device could include a motion detector.

Normally, temperatures will rise during test runs whereby tire pressure will increase. However, the pressure-controlling device of the present invention can also be designed to accommodate drops in tire pressure. For example, the device could incorporate a gas source and a valve (e.g., a normally-closed solenoid valve) can be opened to introduce gas into the tire if the measured pressure is less than the desired test pressure.

Because the pressure-controlling device of the present invention is specifically designed for a test environment, its pressure adjustments are much more refined than those, for instance, of pressure-controlling devices for on-going use on passenger cars (see e.g., U.S. Pat. Nos. 5,928,444 and 5,591,281 to Loewe, U.S. Pat. No. 5,293,919 to Olney, and U.S. Pat. No. 5,472,032 to Winston), for balancing purposes on industrial trucks (see e.g., U.S. Pat. No. 5,505,080 to McGhee and U.S. Pat. No. 4,816,802 to Doerksen) and/or for emergency situations on military vehicles (see e.g., U.S. Pat. No. 4,582,108 to Markow and U.S. Pat. No. 4,570,691 to Martus).

The present invention provides these and other features hereinafter fully described and particularly pointed out in the claims, the following description and annexed drawings setting forth in detail a certain illustrative embodiment of the invention, this being indicative, however, of but one of the various ways in which the principles of the invention may be employed.

### DRAWINGS

FIG. 1 is a schematic perspective view of a dynamic vehicle testing method according to the present invention, this method including the mounting of a pressure-controlling device on the tire/wheel assembly.

FIG. 2 is a front view of the pressure-controlling device mounted on the tire/wheel assembly according to the present invention.

FIG. 3 is a side view of the pressure-controlling device mounted on the tire/wheel assembly.

FIG. 4 is schematic diagram of the components of the pressure-controlling device.

FIG. 5 is a flow chart showing the control operation of the pressure-controlling device.

### DETAILED DESCRIPTION

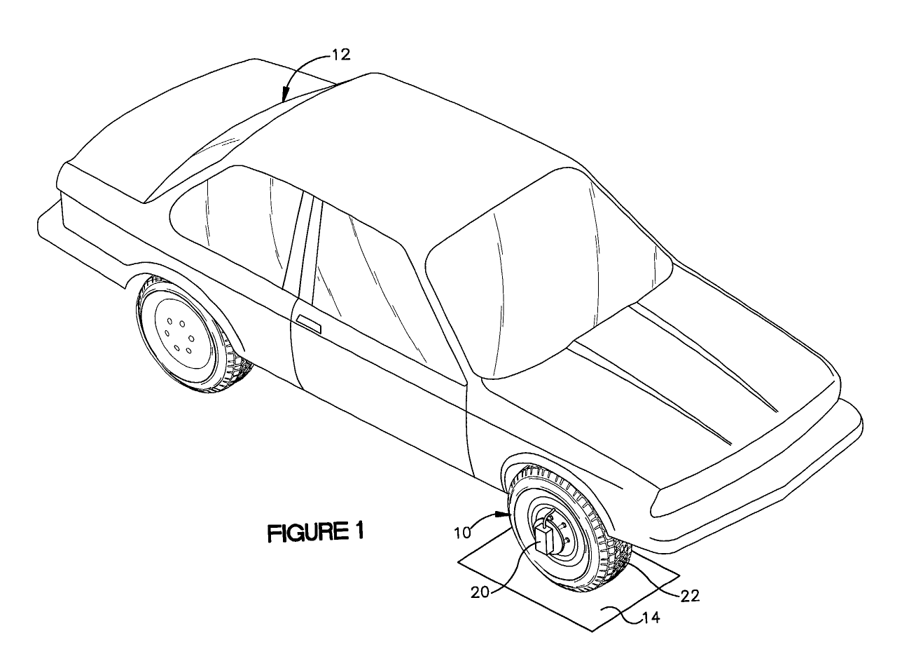

Referring now to the drawings, and initially to FIG. 1, a method for measuring the dynamic properties of a tire/wheel assembly 10 on a moving vehicle 12 is schematically shown. In this method, the vehicle 12 is driven so that the relevant tire/wheel assembly 10 rolls over a plate 14. Instrumentation associated with the plate 14 is used to measure the desired tire properties and a contact patch photograph can be taken. This process is repeated many times to collect enough data to statistically obtain a desired level of confidence in the evaluation. It should be noted that the invention is not limited to this measurement method as other forms of vehicle testing and/or drum testing could be used.

According to the present invention, a pressure-controlling device 20 is mounted on the tire/wheel assembly 10. During the multiple test runs, the device 20 maintains the tire 22 of the tire/wheel assembly 10 at a constant pressure to insure consistency in the collected data. In this manner, as the temperature of the tire/wheel assembly 10 increases during latter test runs, for example, the pressure within the tire 22 will remain the same.

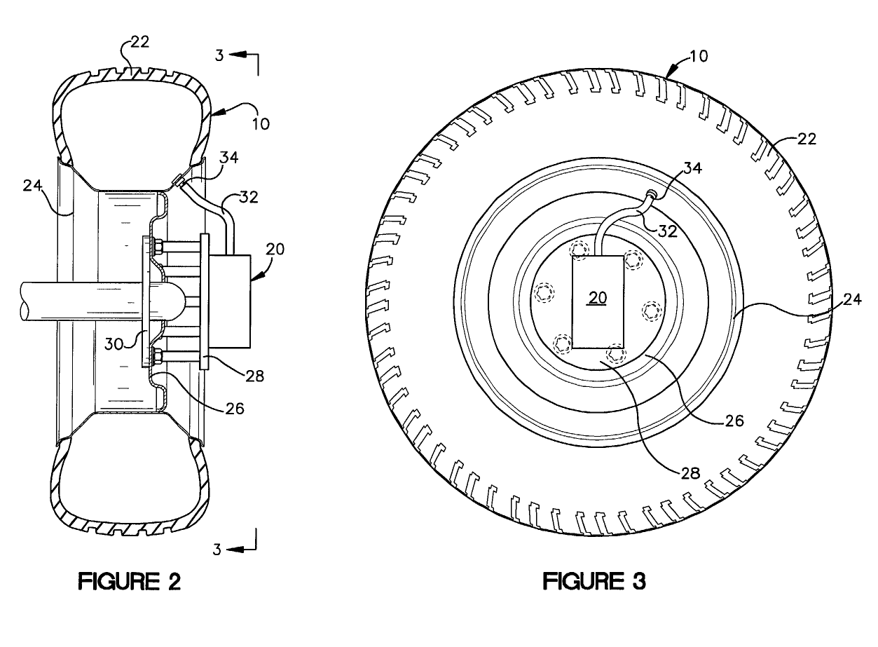

Referring now to FIGS. 2 and 3, the pressure-controlling device 20 and its mounting on the tire/wheel assembly 10 is shown in detail. The wheel 24 of the tire/wheel assembly 10 defines a rotating mounting surface 26 for the device 20. In the illustrated embodiment, the pressure-controlling device 20 is secured to a circular mounting platform 28 which in turn is attached, via nuts and bolts, to the wheel's mounting surface 26. A reinforcement plate 30 may also be provided on the opposite side of the mounting surface 26. In any event, the pressure-controlling device 20 rotates with the tire/wheel assembly 10 when the vehicle is being driven during test runs.

A connection tube 32 is provided to connect the pressure-controlling device 20 to the valve stem 34 of the tire 22. Preferably, this connection tube 20 has quick connect/disconnect features for easy installation and removal. Additionally or alternatively (although not specifically shown in the drawings), the connection tube 32 can have a manual fill valve for pumping the tire 22 between testing procedures without removing the device 20.

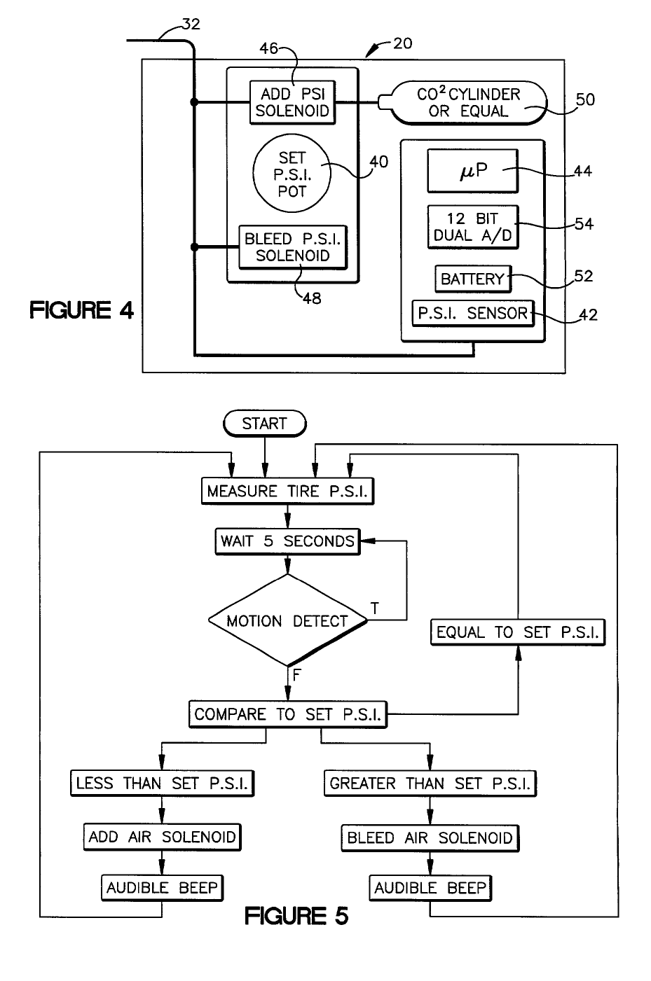

Referring now to FIG. 4, a schematic diagram of the components of the pressure-controlling device 20 are shown. The illustrated device 20 includes a pressure setter 40, for setting the desired test pressure, and a pressure sensor 42, for measuring the actual test pressure. A microprocessor 44 compares signals corresponding to this setting and this measurement, and operates solenoids 46 and 48 accordingly. A pressurized gas source 50 (e.g., a CO₂ cylinder) is connected to the solenoid 46. The components are powered by a battery 52, and an A/D converter 54 is provided. Although not specifically shown in the drawings, the pressure-controlling device 20 may also include a motion detector for determining whether the wheel 12 is moving or is at rest.

FIG. 5 is a flow chart showing the control operation of the pressure-controlling device 20. During the vehicle testing session, the tire pressure is measured via the sensor 42. After an appropriate wait period (e.g., five seconds), a motion detect check is performed to determine if the wheel 10 is moving. If the wheel 10 is at rest, a pressure comparison and pressure adjustment (if necessary) is performed. If the wheel 10 is in motion, the device 20 waits an appropriate time period (e.g., five seconds), and performs another motion detect check. Thus, in the illustrated embodiment, the pressure-controlling device 20 only performs pressure adjustments when the wheel is at rest, that is between rather than during test runs. This adjustment schedule assures that pressure increases/decreases do not occur during a test run. That being said, a pressure-controlling device 20 without a motion detector is possible with, and contemplated by, the present invention.

The measured tire pressure is compared to the desired test pressure (e.g., the setting previously input on the pressure setter 40). If the measured tire pressure is less than the desired test pressure, the normally-closed solenoid valve 46 is opened (via the appropriate signal provided by the microprocessor 44) to add pressurized fluid to the tire 22. If the measured tire pressure is greater than the desired test pressure, the normally-closed solenoid 48 is opened (via the appropriate signal provided by the microprocessor 44) to bleed air from the tire 22. In either case, an audible beep may sound to alert test personnel of the pressure adjustment.

Accordingly, the pressure-controlling device 20 measures tire pressure, compares it to a set value, and then adjusts the pressure accordingly. In most instances, this adjustment will involve bleeding air from the tire 22 due to increased temperature during latter test runs. However, the illustrated device 20 also may increase the pressure within the test tire 20 if it falls below the desired test pressure.

Because the pressure-controlling device 20 is specifically designed for a test environment, its pressure adjustments are much more refined than those used, for instance, on a pressure-controlling device for on-going use on passenger cars, for balancing purposes on industrial trucks, and/or for emergency situations on military vehicles. Specifically, the pressure-controlling device 20 is designed to adjust for pressure increases of less than ¼ psi (0.250 psi), less than ⅛ psi (0.125 psi), less than 1/16 psi (0.062 psi), less than about 1/32psi (0.031 psi), or about 1/36 psi (0.028 psi).

One may now appreciate that the present invention provides a method of maintaining the pressure within a test tire during multiple test runs to evaluate dynamic tire performance. When the temperature of the tire changes during latter test runs, the corresponding pressure change is compensated for to minimize any inconsistencies in data stemming from tire pressure changes. Although the invention has been shown and described with respect to certain embodiments, it is obvious that equivalent and obvious alterations and modifications will occur to others skilled in the art upon the reading and understanding of this specification. The present invention includes all such alterations and modifications and is limited only by the scope of the following claims.

1. A method of testing a tire comprising the steps of:
taking tire-related measurements on a tire/wheel assembly, including the test tire, during multiple test runs;
maintaining the pressure within the test tire at a desired test pressure throughout the multiple test runs with a pressure-controlling device mounted on the tire/wheel assembly; and
compiling data from the multiple test runs to evaluate tire performance.

2. A method as set forth in claim 1, wherein said pressure-maintaining step comprises the step of releasing gas from the tire if the tire pressure exceeds the desired test pressure by 1/36 psi.

3. A method as set forth in claim 2, wherein said releasing step is performed when the tire/wheel assembly is at rest between test runs and wherein the pressure-controlling device includes a motion detector to determine whether the tire/wheel assembly is at rest.

4. A method as set forth in claim 1, wherein said pressure-maintaining step comprises the steps of:
measuring actual tire pressure;
comparing the measured tire pressure to the desired test pressure; and
adjusting the tire pressure if the measured tire pressure is above or below the desired test pressure by at least ¼ psi.

5. A method as set forth in claim 4, wherein said adjusting step comprises adjusting the tire pressure if the measured tire pressure is above or below the desired test pressure by at least 1/16 psi.

6. A method as set forth in claim 4, wherein said adjusting step comprises adjusting the tire pressure if the measured tire pressure is above or below the desired test pressure by at least 1/36 psi.

7. A method as set forth in claim 4, wherein said pressure-maintaining step comprises the step of setting the desired test pressure on the pressure-controlling device prior to the test runs.

8. A method as set forth in claim 4, wherein said adjusting step comprises opening a normally closed solenoid valve to bleed air from the tire when the measured tire pressure exceeds the desired test pressure.

9. A method as set forth in claim 4, wherein said adjusting step is performed when the vehicle is at rest between test runs.

10. A method as set forth in claim 1, wherein the wheel of the tire/wheel assembly has a rotating mounting surface on which the pressure-controlling device is mounted whereby the pressure-controlling device rotates with the tire/wheel assembly.

11. A method as set forth in claim 1, wherein said measurement-taking step comprises driving the vehicle so that the relevant tire rolls over a plate having instrumentation associated with the plate to measure tire properties.

12. A pressure-controlling device for taking test measurements of a tire being rotated during multiple test runs to evaluate dynamic tire performance, said device comprising:
a tube which is adapted to connect to a fluid inlet/outlet of the tire;
a valve which can be opened to allow fluid to pass through the tube;
a pressure sensor which measures the pressure of the tire; and
a controller which compares the measured pressure to a desired test pressure and opens the valve when the difference between the measured pressure and the desired test pressure exceeds ¼ psi.

13. A pressure-controlling device as set forth in claim 12, wherein the controller opens the valve to adjust the pressure if difference exceeds ⅛ psi.

14. A pressure-controlling device as set forth in claim 12, wherein the controller opens the valve to adjust the pressure if the difference exceeds 1/16 psi.

15. A pressure-controlling device as set forth in claim 12, wherein the controller opens the valve to adjust the pressure if the difference exceeds 1/32

16. A pressure-controlling device as set forth in claim 12, wherein the controller opens the valve to adjust the pressure if the difference exceeds 1/36 psi.

17. A pressure-controlling device as set forth in claim 12, wherein the valve is a normally-closed solenoid valve.

18. A pressure-controlling device as set forth in claim 12, further comprising a gas source which can be opened to introduce gas through the connection tube and into the tire, the controller opening the valve to adjust the pressure if the measured pressure is less than the desired test pressure.

19. A pressure-controlling device as set forth in claim 12, further comprising a pressure setter for setting the desired test pressure.

20. A pressure-controlling device as set forth in claim 12 further comprising a motion detector for detecting when the vehicle is at motion and wherein the controller adjusts the pressure when the motion detector indicates that the vehicle is at rest.

21. A pressure-controlling device as set forth in claim 12, further comprising a fluid source and a valve which can be opened to introduce fluid from the source through the connection tube and into the tire; and wherein the controller opens the valve to adjust the pressure if the measured pressure is less than the desired test pressure by at least ¼ psi.

22. A method of testing a tire of a tire/wheel assembly rotated during multiple test runs to evaluate dynamic tire performance, said method comprising the steps of:
mounting the pressure-controlling device of claim 12 onto the tire/wheel assembly to maintain the pressure during multiple test runs;
taking test measurements while the tire/wheel assembly vehicle is rotated during the multiple test runs; and
compiling data from the multiple test runs to evaluate tire performance.

23. In combination, a vehicle and the pressure-controlling device of claim 12 mounted on the tire/wheel assembly of the vehicle.

24. The combination set forth in claim 23, wherein the pressure-controlling device rotates with the tire/wheel assembly when the vehicle is being driven.
